(19) United States
(12) Patent Application Publication
(10) Pub. No.: US 2005/0129374 A1
(43) Pub. Date: Jun. 16, 2005

(54) Modular optoelectronic package

(76) Inventor: Eric J. Zbinden, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/734,456

(22) Filed: Dec. 12, 2003

(51) Int. Cl. G02B 6/36

(52) U.S. Cl. 385/94

(57) ABSTRACT

Each functional piece for a particular optoelectronic product (e.g., laser, tap, modulator, Variable Optical Amplifier (VOA), etc.) may be packaged individually. Each package may be equipped with one or more optical windows through which collimated beams are allowed to pass. The individual packages or modules may be mated and aligned together in such a way that the output-collimated beam of one package becomes the input-collimated beam of a second package. In this fashion, any number of individual packages may be linked together to form an optical device performing a more complex operation.

### FIELD OF THE INVENTION

Embodiments of the present invention relate to optoelectronics and, more particularly, to modular optoelectronic packages.

### BACKGROUND INFORMATION

As optoelectronic components are becoming more complex and more functionality is integrated or combined into them, the overall manufacturing yield decreases. This is due, in part, to the fact that more critical manufacturing steps are necessary to build the components and thus the yield of each manufacturing step multiplies to decrease the overall yield. Further, traditional fiber pigtail coupling from one module to another limits miniaturization, increases overall manufacturing complexity and decrease reliability.

Optoelectronics packaging is one of the most difficult and costly operations in optoelectronics manufacturing. Optoelectronic packages provide submicron alignment between optical elements, high-speed electrical connections, excellent heat dissipation, and high reliability. Providing such features has resulted in optoelectronic packages that may be larger, costlier and more difficult to manufacture than electronic packages. In addition, current designs of optoelectronic packages and associated fabrication processes are ill adapted for automation because today's high-performance butterfly packages are characterized by a large multiplicity of mechanical parts (submounts, brackets, ferrules, etc.), three-dimensional (3D) alignment requirements, and poor mechanical accessibility.

For manufacturers, the trends driving the demand for new optical packaging are providing an opportunity for reducing the cost of developing 10 Gbps application technology and a challenging market increasingly characterized by a diversity of applications. Consequently, manufacturers need an approach to component-level packaging that can be applied to both transmitter and receiver modules and to various products and applications without the need for a full redesign of each new component package. Within such an approach, manufacturers should be able to precisely align a laser chip or photodiode to single-mode fiber with high coupling efficiency and maintain this alignment, meet the RF (radio frequency), thermal, and hermetic sealing requirements and provision them for direct integration into the package for cost, space, and power savings; and simultaneously develop a low-cost automation capability for easily scalable manufacturing.

An example of one type of multi-module package, may be a 10 Gb/s tunable transceiver. The optics of this transceiver may be comprised of two optical modules linked by a fiber. The first module may contain a tunable laser and the second module may contain a modulator. The optical output of the first module in the form of an optical fiber is connected to the optical input of the second module. The resulting apparatus is two modules linked by a fragile optical fiber. Moreover, the fiber length between the two modules needs to be precisely controlled to allow proper mating and the fiber typically should not be bent below a minimum radius of 10 to 30 millimeters.

In a second packaging example, the tunable laser may be co-packaged with the modulator. This may provide the most compact design. However, yield loss when assembling the modulator may multiply with the yield loss associated with the tunable laser assembly and result in a lower overall yield for the co-package apparatus. Furthermore if another function needs to be added to the apparatus a complete redesign would likely be necessary.

### BRIEF DESCRIPTION OF THE DRAWINGS

FIG. 1 is an example of an optoelectronic apparatus assembled from a plurality of optoelectronic modules according to an embodiment of the invention;

FIG. 2 is a single open window module;

FIG. 3 is a single closed or hermetically sealed window module;

FIG. 4 is a dual inline open window module;

FIG. 5 is a dual inline closed or hermetically sealed window module;

FIG. 6 is a dual right-angle window module; and

FIG. 7 is a triple window module.

### DETAILED DESCRIPTION

According to embodiments of the present invention, each functional piece for a particular optoelectronic product (e.g., laser, tap, modulator, Variable Optical Amplifier (VOA), etc.) may be packaged individually. Each package may be equipped with one or more optical windows through which collimated beams are allowed to pass. The individual packages or modules may be mated and aligned together in such a way that the output-collimated beam of one package becomes the input-collimated beam of a second package. Once aligned, the packages may be attached together in a permanent manner. The attachment methods may include, for example, laser welding, epoxy or soldering. The resulting apparatus is modular yet compact and easy to handle. Hermetic modules can be combined with non-hermetic modules. Passive and active, cooled and uncooled modules can also be mated as desired. In this fashion, any number of individual modules may be linked together to form an optical device performing a more complex operation.

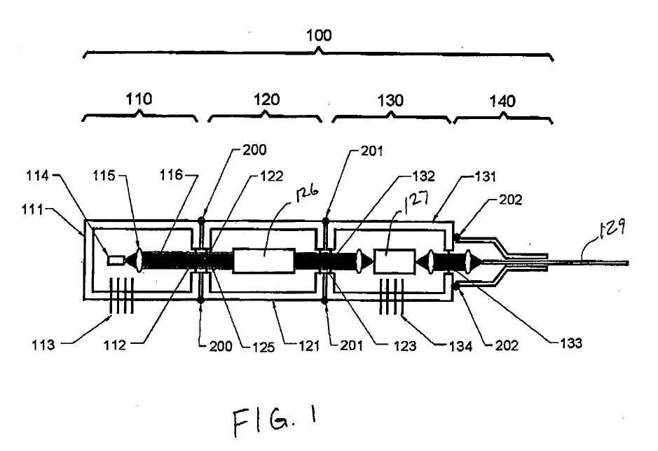

Referring now to FIG. 1, there is shown an optoelectronic component 100 being assembled using a plurality of modules, in this particular case from three modules, 110, 120, and 130. Each of the modules performs a particular function and may be combined to make a larger, more complex component 100. For example, the first module 110 may comprise a laser source, the second module 120 may comprise an optical isolator, and the third module may comprise a modulator.

As shown, a first module 110 comprises a package 111 with an integrated optical window 112 and electrical connections 113. A second module 120 and a third module 130 each comprise a package, 121 and 131, an input window, 122 and 132, an output window, 123 and 133. Package 130 may also contain electrical leads 134. The component 100 may be completed by an optical fiber pigtail assembly 140. Package 110 and 120 are aligned and attached together, for example, by spot laser welds 200, similarly package 120 is attached to package 130 by spot laser weld 201. Other embodiments may use epoxy, solder or other suitable attachment method.

Module 110 contains a laser source 114 emitting a laser beam 116 that is collimated by an optical lens 115 and launched through optical window 112. The optical window 112 is transparent to the beam 116. If hermetic sealing is not required for a particular package, the optical window may simply comprise an opening allowing the beam 116 to pass. The second module 120 receives a collimated laser beam 125 and acts upon it in some fashion. In this case, the second module 120 may contain an optical isolator 126. Similarly module 120 outputs a collimated beam that is captured by module 130. Module 130 here could be, for example, an optical modulator 127. The collimated beam out of module 130 is injected into a fiber 129 by module 140.

As one skilled in the art will recognize, a variety of such modules may be mixed and matched to form a more complex component. The resulting apparatus is highly modular yet compact and easy to handle. The manufacturing yield may be higher since individual modules can be tested separately before being mated. Further, adding or removing functionalities does not require redesign of any subsystem. Customization to satisfy different customers would require minimum resources and inventories may be minimized by only storing individual modules and not final assemblies. Moreover, rapid assembly of modules allows for manufacturing flexibility and fast responses to customer requests for customized components.

FIGS. 2-7 show various configurations for the modules, and are by no means exhaustive. The particular function of the module may be one or more of a variety of optoelectronic functions, including simply spacer functions, with the windows positioned accordingly. For example, FIG. 2 comprises a single, open window package having only one opening 200 for allowing a beam to be input or output. FIG. 3 comprises a single, closed or hermetic window package. In this case, a transparent material may be used for window 302. Since the modules in FIGS. 2 and 3 comprise only one window, they may be more suited housing a laser source or optical receiver or detector.

FIG. 4 shows a dual in-line open widow package having a first window 304 and a second window 306. FIG. 5 similarly shows a dual inline closed or hermetic window package comprising transparent windows 308 and 310.

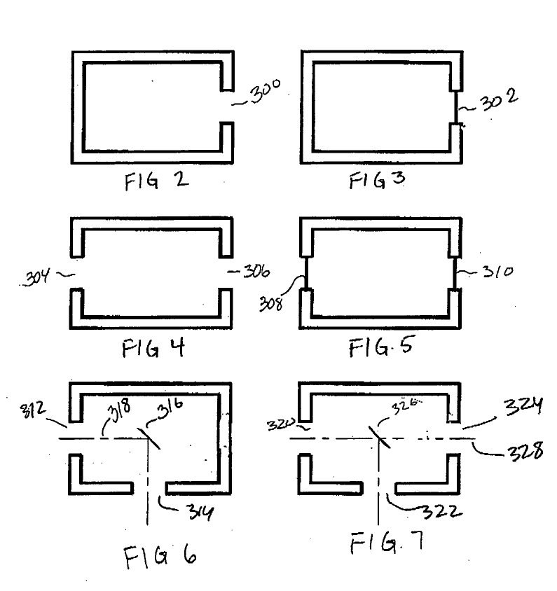

FIG. 6 shows a dual right-angle window package having windows 312 and 314. In this case, the package may comprise a mirror or reflective surface 316 for redirecting a beam 318. FIG. 7 shows a triple window package having three windows 320, 322, and 324. In this case, the package may comprise a splitter 326 for splitting a beam 328. It will be evident to one skilled in the art that the number and location of the windows as well as the geometry of the package are not limited to those shown in FIGS. 1-7.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An optoelectronic apparatus, comprising:
a first package comprising a first window, said first package to house a device to perform a first optoelectronic function; and
a second package comprising a second window, said second package to house a device to perform a second optoelectronic function;
said first package attached to said second package to allow a light beam to pass between said first window and said second window.

2. The optoelectronic apparatus as recited in claim 1, wherein either of said first window and said second window comprise a transparent material to form a hermetic package.

3. The optoelectronic apparatus as recited in claim 1 wherein either of said first window and said second window comprise an opening.

4. The optoelectronic apparatus as recited in claim 1 wherein said second package comprises a third window to couple with a third package.

5. The optoelectronic apparatus, as recited in claim 1 wherein said second package comprises a feedthrough for a fiber.

6. The optoelectronic apparatus as recited in claim 1 wherein said device comprises a passive device.

7. The optoelectronic apparatus as recited in claim 6 wherein said passive device comprises one of a mirror and a splitter.

8. The electronic apparatus as recited in claim 1 wherein said device comprises an active device.

9. The electronic apparatus as recited in claim 8 wherein said active device comprises one of a laser, and amplifier, a modulator, and an optical isolator.

10. A method, comprising:
providing a plurality of packages each housing a device for performing an optoelectronic function;
providing at least one window in each of said packages;
coupling said plurality of packages together; and
transmitting a beam between windows of adjacent packages.

11. The method as recited in claim 10, further comprising:
one of soldering, welding or epoxying said plurality of packages together.

12. The method as recited in claim 10, further comprising:
providing a package comprising a feedthrough for a fiber.

13. The method as recited in claim 10 wherein said device comprises a passive device.

14. The method as recited in claim 13 wherein said passive device comprises one of a mirror and a splitter.

15. The method as recited in claim 10 wherein said device comprises an active device.

16. The method as recited in claim 15 wherein said active device comprises one of a laser, an amplifier, a modulator, and an optical isolator.

17. A modular optoelectronic system, comprising:
a plurality of hermetically sealed packages, each comprising at least one window;
a device in each of said plurality of packages to perform a particular function for an optoelectronic product;
coupling means for coupling ones of said packages together to pass a collimated beam between adjacent windows to optically connect each said device to form said optoelectronic product.

18. The modular optoelectronic system as recited in claim 17, further comprising:
a package including a fiber feedthrough.

19. The modular optoelectronic system as recited in claim 17 wherein each said device comprises one of a passive device and an active device.

20. The modular optoelectronic system as recited in claim 17 wherein said coupling means comprises one of solder, weld, and epoxy.
